(19) United States
(12) Patent Application Publication
(10) Pub. No.: US 2008/0010124 A1
(43) Pub. Date: Jan. 10, 2008

(54) MANAGING COMMITMENTS OF TIME ACROSS A NETWORK

(75) Inventors: Timothy S. Paek, Sammamish, WA (US); Christopher A. Meek, Kirkland, WA (US); David M. Chickering, Bellevue, WA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: MICROSOFT CORPORATION, Redmond, WA (US)

(21) Appl. No.: 11/426,679

(22) Filed: Jun. 27, 2006

(51) Int. Cl. G06Q 30/00

(52) U.S. Cl. 705/14

(57) ABSTRACT

A service manager manages connection tokens in a network of users. The connection token has a plurality of defined terms and can be representative of a commitment of time for a user in the network. Connection tokens can be used to engage in a real-time communication with another user in exchange for a fee. The service manager manages possession of the connection tokens amongst the users of the network and executes the connection token in accordance with the defined terms. Additionally, the service manager can facilitate real-time communication among users based on the connection tokens.

### BACKGROUND

Many times, users of a network-based environment desire to obtain goods from other users of the environment and/or obtain information from other users of the environment. Users of these network-based environments are willing to pay other users of the environment a fee in exchange for the good and/or the information.

Network-based environments exist that provide users with help finding information and answering questions. In these environments, a user submits a question and sets a fee he/she is willing to pay to have a researcher answer his/her submitted question. A researcher, who is generally an experienced web researcher with strong communication skills and often has expertise in various fields, answers the question in exchange for the fee set by the user.

In some circumstances, a user may be willing to offer his/her time in exchange for a fee rather than offering a good for sale. Such a user may find that selling his/her time is more valuable than selling goods and selling his/her time is most practically disseminated as a real-time communication. In addition, a user's time may be so valuable that other users may want to buy, sell and trade the user's time. However, none of the above-discussed network-based environments are capable of allowing a user to sell their time in exchange for a fee or for other users to buy, sell and trade the user's time.

The discussion above is merely provided for general background information and is not intended to be used as an aid in determining the scope of the claimed subject matter.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

A service manager manages connection tokens in a network of users. The connection token has a plurality of defined terms and can be representative of a commitment of time for a user in the network. Connection tokens can be used to engage in a real-time communication with another user in exchange for a fee. The service manager manages possession of the connection tokens amongst the users of the network and executes the connection token in accordance with the defined terms. Additionally, the service manager can facilitate real-time communication among users based on the connection tokens.

### BRIEF DESCRIPTION OF THE DRAWINGS

FIG. 1 illustrates a network-based service environment.

FIG. 2 is a flowchart illustrating a method of managing tokens in a network-based service environment.

FIG. 3 is an exemplary data structure of a connection token.

FIG. 4 is a flowchart illustrating a method of committing time to engage in a real-time communication in a network of users.

FIG. 5 illustrates an exemplary communication architecture having a service agent.

FIG. 6 is an exemplary computing system for implementing a service agent and/or a client device.

FIG. 7 is an exemplary mobile device for implementing a client device.

### DETAILED DESCRIPTION

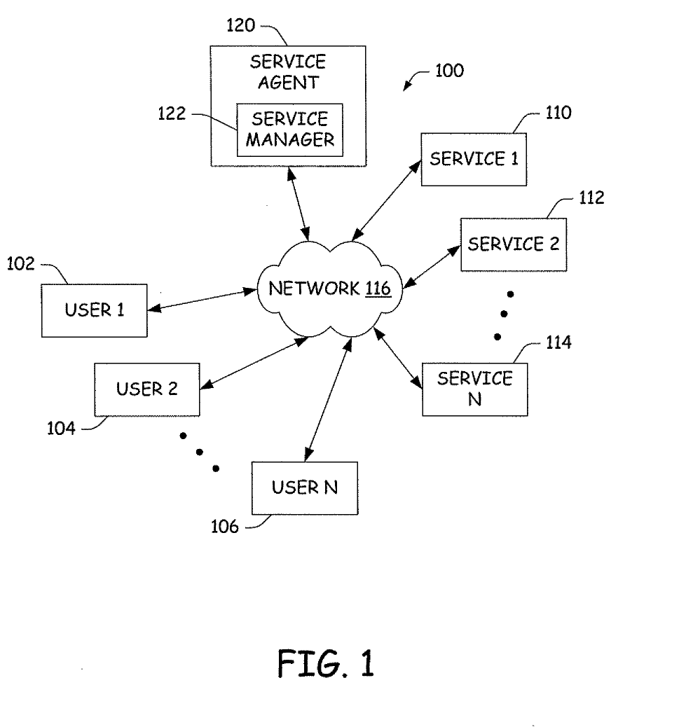

FIG. 1 is a block diagram of a network-based service environment 100. Service environment 100 includes a plurality of users, for example user 102, user 104 and user 106. Each of the plurality of users 102, 104 and 106 can access a plurality of services, for example services 110, 112 and 114 through a network 116. Additionally, each of the users 102, 104 and 106 can connect with other users through network 116. Additionally, users 102, 104 and 106 can connect with service agent 120 through network 116. Service agent 120 can store information related to each of the users 102, 104 and 106 as well as facilitate communication among each of the users 102, 104, 106 and each of the services 110, 112 and 11 4. Services 110, 112 and 114 can provide various sources of information for access by users 102, 104 and 106. For example, information can relate to stock quotes, weather, travel information, news, music, advertisements, etc. Service agent 120 can include personal information for each of the users 102, 104 and 106 to customize access to services 110, 112 and 114. For example, user 102 may wish to only receive particular stock quotes from service 112. Service agent 120 can store this information.

In one embodiment, a user of the network-based service environment 100, such as user 102, 104 or 106 (FIG. 1), can be a user who is willing to commit time to engage in a real-time communication with another user of the network 100 in exchange for a fee. This commitment of time in exchange for a fee is represented as a connection token. To commit time, users of the network-based service environment 100 can utilize a service manager 122 within service agent 120 to manage connection tokens. The real-time connection can be made between two users or among more than two users. The discussion below relates to connecting one user to another user. However, one skilled in the art can extend the real-time communication to include two or more users, as desired.

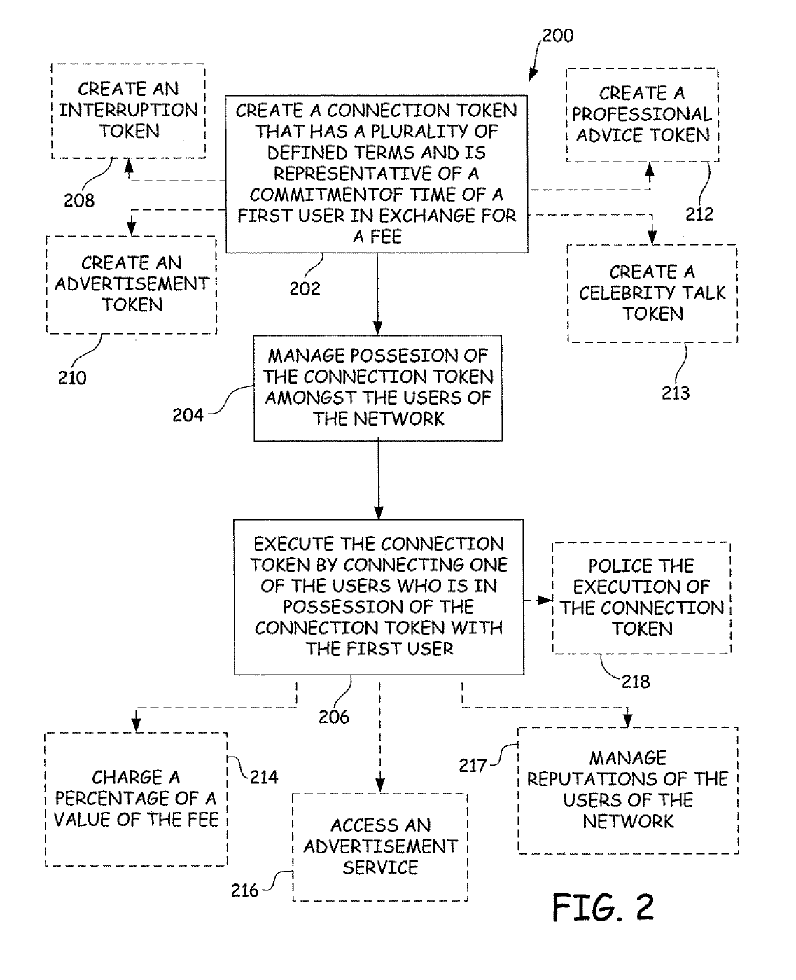

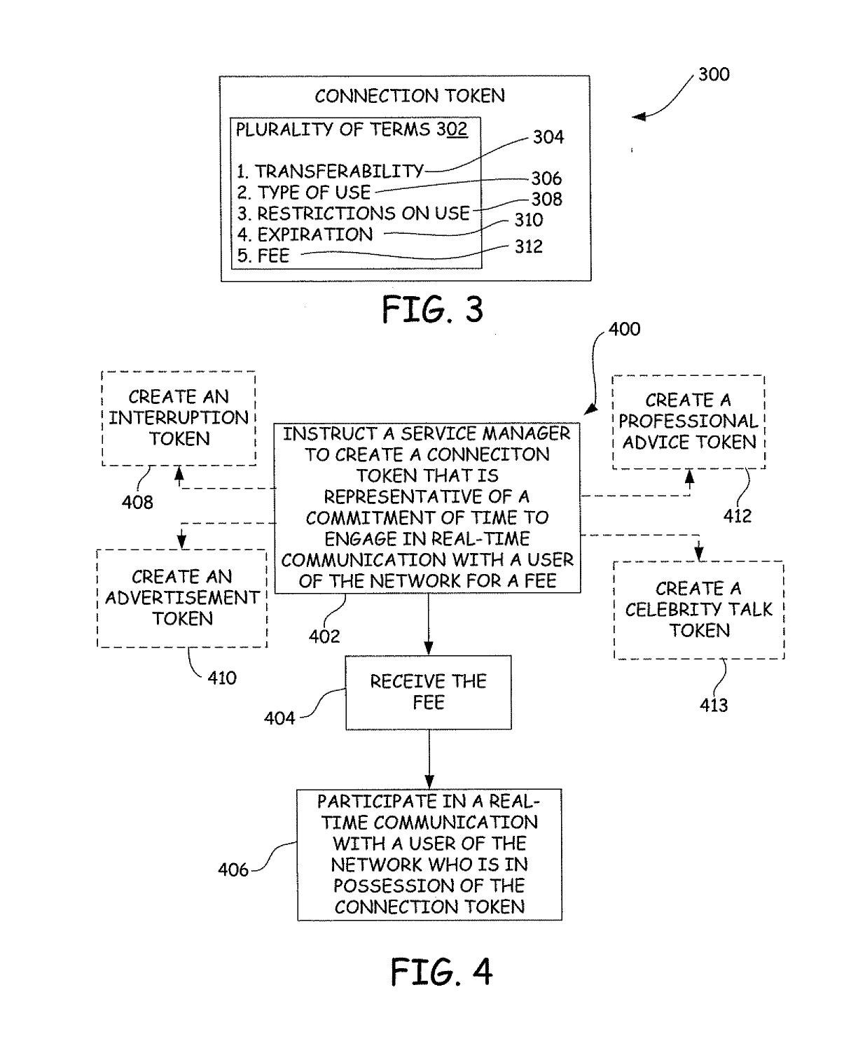

FIG. 2 is a flowchart illustrating a method of managing connection tokens in network-based service environment 100 (FIG. 1). At block 202, a service manager 122 creates a connection token. As previously described, the connection token is representative of a commitment of time of a user of the network 100 to engage in a real-time communication with another user in the network in exchange for a fee. The connection token created is a data structure stored on a computer-readable medium and includes a plurality of defined terms or properties. A simplified data structure of a connection token 300 is illustrated in FIG. 3.

Connection token data structure 300 includes a plurality of defined terms or properties 302. Although FIG. 3 illustrates data structure of connection token 300 as having a transferability term 304, a type of use term 306, a restriction on use term 308, an expiration term 310 and a fee term 312, it should be understood that any connection token may or may not have all of these types of terms and can include other types of terms not expressly described. For example, a connection token may or may not have any restrictions on its use, may or may not have an expiration and may or may not be transferable.

Transferability term 304 defines how possession of a connection token can be transferred. Upon creation of a connection token, it can be expressly defined that the connection token can be bought and sold among users of network 100 (FIG. 1). For example, if user 102 (FIG. 1) is the user whose commitment of time is represented in connection token 300 and user 104 (FIG. 1) and user 106 (FIG. 1) are users of network 100, such a transferability term 302 allows user 102 to sell the connection token to user 104. It is also possible that after user 104 is in possession of connection token 300, user 104 can either request that the connection token be executed or can sell the connection token to another user, such as user 106, for a fee. Transferability term 302 can expressly limit the connection token to a single transfer, a set amount of transfers or not limit the number of transfers that the connection token can undergo.

Type of use term 306 defines a type of connection token 300. When connection token 300 is created in block 202 of FIG. 2, the connection token can be a variety of different types of connection tokens. In one embodiment and as illustrated as an alternative embodiment (as indicated by the dashed line) in block 208 of FIG. 2, the connection token can be created as an interruption token to be defined in type of use term 306. For example, user 102 may not want to be interrupted, but doesn't want to turn off his or her service with service agent 120. Therefore, the service manager 122 within agent 120 creates an interruption token. The interruption token sets a fee that other users must pay in order to possess the interruption token and have the right to interrupt user 102. Payment of the fee to possess the interruption token can be contingent on the call reaching user 102 and can be revocable by user 102.

In another embodiment and as illustrated as an alternative embodiment (as indicated by the dashed line) in block 210 of FIG. 2, the connection token can be created as an advertisement token to be defined in type of use term 306. The advertisement token is representative of the commitment of time of user 102 to listen and/or view at least one advertisement provided by one of the other users (i.e., 104, 106) of network 100 in exchange for the fee. User 104 or 106 can be an individual, an individual representing an organization or an organization. The advertisement token sets a fee that the other user 104 or 106 is willing to pay to user 102 in exchange for user 102 listening and/or viewing at least one advertisement. For example, the other user 104 or 106 may be willing to pay user 102 $0.50 to a watch a 2 minute advertisement video.

In another embodiment and as illustrated as an alternative embodiment (as indicated by the dashed line) in block 212 of FIG. 2, the connection token can be created as a professional advice token to be defined in type of use term 306. For example, user 102 can be a professional plumber who is willing to commit time to consult with another user of the network 100 about her expertise in plumbing in exchange for a fee. The professional advice token can be contingent on user 102's availability.

In yet another embodiment and as illustrated as an alternative embodiment (as indicated by the dashed line) in block 213 of FIG. 2, the connection token can be created as a celebrity talk token. For example, user 102 can be a celebrity who is willing to speak to another user of the network for a set amount of time in exchange for a fee. In general, the celebrity talk token is likely contingent on a date and time at which the celebrity talk token can be executed.

In still another embodiment, type of use term 306 can also indicate how many times the connection token can be used. The connection token can be a single use token or a multiple use token. In some circumstances, a connection token can be created that allows a user to use it only once. In other circumstances, a connection token can be created that allows a single user to use it multiple times or allows many different users to use the connection token multiple times. In general, the interruption token and the celebrity talk token are examples of single use tokens. In general, the advertisement token and the professional advice token are examples of multiple use tokens.

Restriction of use term 308 defines what type of use restrictions are associated with the connection token. Connection tokens can be restricted such that only certain types of users can use the connection token, the date a connection token can be used and time of day the connection can be used. For example, a celebrity talk token may restrict usage of the token to a certain time of a certain day. In addition, a connection token can restrict the topics that can be discussed over a real-time communication. For example, a celebrity talk token may restrict communication about certain subjects or restrict certain subjects from the communication. A subject that could be restricted could be information related to a celebrity's personal life.

Expiration term 310 defines an expiration date when a connection token expires. The expiration date can include a date and time. For example, a celebrity talk token may stipulate a date and a time at which the real-communication needs to be completed. If the communication does not take place before the expiration term date, then after the expiration date, the celebrity talk token becomes useless.

Fee term 312 defines what type of fee or payment is needed to satisfy the connection token. The fee or payment can be required to be in a variety of different forms. For example, the fee can be required to be a fixed rate (i.e., $10/hour of communication), a flat rate (i.e., $20) or a variable rate that depends on a variety of factors. For example, a variable rate can depend on the time of day that the connection token is to be used or the distance between the connections.

At block 204, service manager 122 within agent 120 manages possession of connection tokens amongst the users of network 100. Connection tokens can be bought and sold between users of network 100. Therefore, service manager 122 keeps track of what users have possession of each created connection token. The following two examples describe two different ways service manager 122 can manage possession of connection tokens. In the first example, service manager 122 can disseminate a connection token to a user. In such an example, the user can hold the computer-readable connection token data structure on a computer-readable medium until either the user decides to sell the connection token or the user decides to use the connection token. In the second example, service manager 122 does not disseminate any of the computer-readable connection token data structures. In this example, service manager 122 keeps a record of which connection token belongs to which user and stores the computer-readable connection token data structures in service agent 120.

At block 206, service manager 122 executes the connection token in accordance with the defined terms and connects one of the users of network 100 who is in possession of the connection token with the user whose commitment of time is represented in the connection token. The connection is a real-time communication between the user who is in possession of the token and the user whose commitment of time is represented in the connection token. For example, the real-time communication can be connected through a plain old telephone system (POTS) network using a telephone or cell phone or an internet protocol (IP) network that can provide real-time voice through a voice over Internet protocol (VOIP) source, real time text using instant messaging (IM) or real time video and audio, such as videoconferencing and teleconferencing.

Each real-time connection made can be an anonymous connection. An anonymous connection allows users of network 100 to be unaware of the identification of each other. Although each user is registered with service agent 120 and identified by personal information in service agent 120, agent 120 allows the user who is in possession of the connection token and the user whose commitment of time is represented in the connection token to be connected while remaining unaware of each others identification. Anonymous connection is also applicable even in the context of the celebrity talk token. Although the user who is in possession of the celebrity talk token knows the identification of the celebrity they are to have a real-time communication with, the user who is in possession of the celebrity talk token will not be allowed access to the celebrity's personal phone number, email address and etc.

Blocks 214 through 218 illustrate optional additional methods for the method illustrated in blocks 202 through 206. Blocks 214 and 216 provide a method for service agent 120 to be compensated for allowing users to use the system. At block 214, service agent 120 charges a percentage of a value of the fee. A percentage fee allows a user of network 100 to use connection tokens by giving a portion of the fee to service agent 120. At block 216, service agent 120 can access an advertisement service, such as service 110, 112 or 114 (FIG. 1) to feed to users of network 100. Advertisements are fed to the user who is in possession of the connection token and the user whose commitment of time is represented in the connection token while they are being connected. Advertisements can be audio, visual or audiovisual depending on the client device (i.e. computing device or telephone) each user is using to access the system.

At block 217, service manager 122 manages reputations of each user of network 100. To manage reputations of each user of network 100, service manager 122 collects reviews, Service manager 122 collects a user review from the user who is in possession of a connection token about the user whose commitment of time is represented in the connection token after disconnection from the real-time communication. Service manager 122 also collects a user review from the user whose commitment of time is represented in the connection token about the user who is in possession of a connection token. Service manager 122 can provide incentives to users in network 100 to submit reviews. Service manager 122 can use the reviews to evaluate each user and assign each user a reputation value. The reviews aid in preventing users from abusing the system and also aids users in making decisions in regards to buying connection tokens and selling connection tokens.

At block 218, service manager 122 can also be responsible for policing the execution of the connection token. To police the execution of connection tokens, service manager 122 can record the fulfillment of a real-time communication. These records can be kept to prove that the user in possession of an executed connection token participated in a real-time communication and that the user whose commitment of time is represented in the executed connection token participated in the real-time communication. Such recordings can prevent users from purporting that the execution of a connection token failed. In addition, service manager 122 can also provide arbitration to users of the network if disagreements arise.

In another embodiment, FIG. 4 is a flowchart illustrating a method of committing time to engage in a real-time communication in a network 100 (FIG. 1) of users. In accordance with this embodiment, a user using a client device is configured to perform the steps illustrated in FIG. 4. At block 402, the client device transmits instructions to service manager 122 to create a connection token that has a plurality of defined terms. As previously described, the connection token is representative of a commitment of time to engage in a real-time communication with a user of network 100 in exchange for a fee. As also previously described, the connection token created is a data structure stored on a computer-readable medium and includes a plurality of defined terms or properties. A simplified data structure of a connection token 300 is illustrated in FIG. 3.

The data structure of connection token 300 includes a plurality of defined terms or properties 302. Although FIG. 3 illustrates the data structure of connection token 300 as having a transferability term 304, a type of use term 306, a restriction on use term 308, an expiration term 310 and a fee term 312, it should be understood that any given connection token may or may not have all of these types of terms and can include other types of terms not expressly described. For example, a connection token may or may not have any restrictions on its use, may or may not have an expiration and may or may not be transferable. Details regarding each term or property is discussed above in detail.

Type of use term 306 defines a type of connection token 300. When the client device instructs service manager 122 to create connection token data structure 300 in block 402 of FIG. 4, the connection token can be a variety of different types of connection tokens. The variety of different types of connection tokens are included as alternative embodiments (as indicated by dashed lines) and are an interruption token instructed to be created in block 408; an advertisement token instructed to be created in block 410; a professional advice token instructed to be created in block 412 and a celebrity talk token instructed to be created in block 413. Each type connection token is described in detail above.

At block 404, the client device receives a fee from service manager 122. The fee is representative of the fee term established upon creation of the connection token. As previously described, the fee can be required to be in a variety of different forms. For example, the fee can be required to be a fixed rate (i.e., $10/hour of communication), a flat rate (i.e., $20) or a variable rate that depends on a variety of factors. For example, the variable rate can depend on the time of day that the connection token is to be used or the distance between the connections.

At block 406, the client device participates in a real-time communication with the user of network 100 who is in possession of the connection token. As previously discussed, real-time communication can be connected through a POTS and/or an IP network, for example.

As also previously discussed, each real-time connection can be an anonymous connection. An anonymous connection allows the users to be unaware of the identification of each other. Although the users are registered with service agent 120, agent 120 allows the users to connect while being unaware of each others identification.

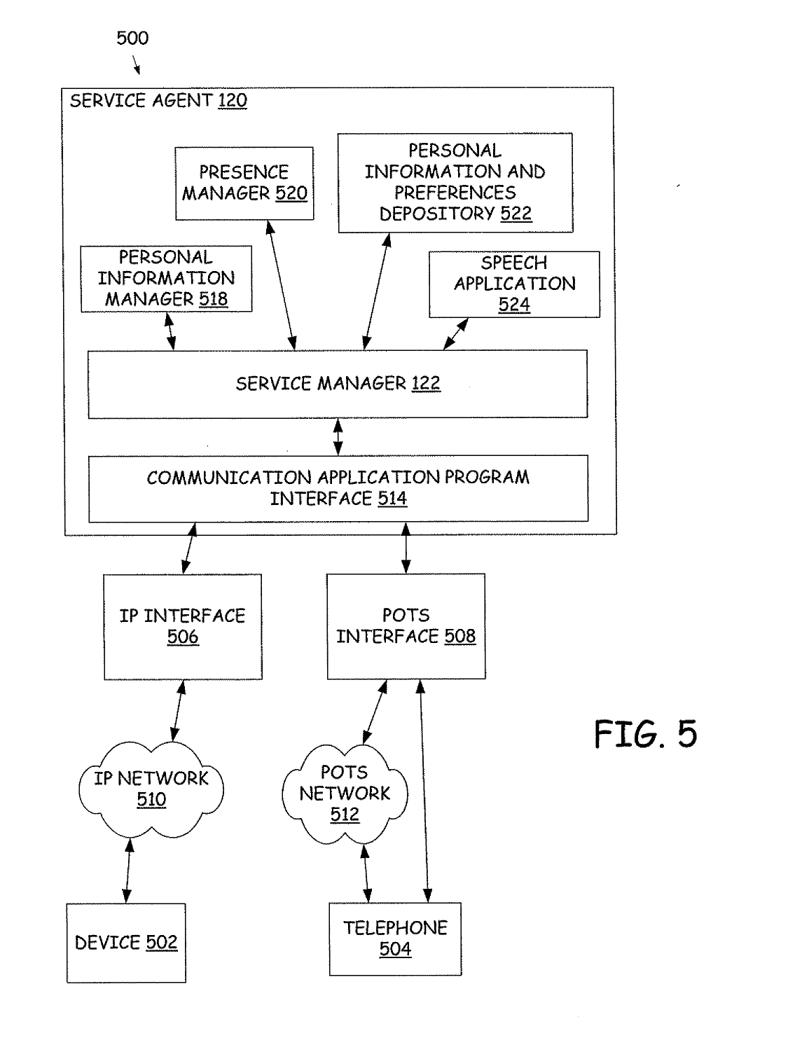

The above description of illustrative embodiments is described in accordance with a network-based service environment having a service agent and client devices. Below are suitable computing environments that can incorporate and benefit from these embodiments. FIG. 5 illustrates exemplary communication architecture 200 with a service agent 120 as discussed above. Agent 120 receives communication requests and messages from a user (for example users 102, 104 and 106) and performs tasks based on the requests and messages. The messages can be routed to a destination. The user can access agent 120 through any device, telephone, remote personal information manager, etc. that connects to agent 120. Information from the user can take many forms including web-based data entry, real time voice (for example from a simple telephone or through a voice over Internet protocol (VOIP) source), real time text (such as instant messaging (IM)), non-real time voice (for example a voicemail message) and non-real time text (for example through short message service (SMS) or email). Tasks are automatically performed by agent 120, for example speech recognition, accessing services, scheduling a calendar, voice dialing, managing contact information, managing messages, call routing and interpreting a caller identification.

In one embodiment, service agent 120 can be implemented on a general purpose computer. Agent 120 represents a single point of contact for a user or a group of users. Thus, if a person wishes to contact the user or group of users associated with agent 120, communication requests and messages are passed through agent 120. In this manner, the person need not have all contact information for another user or group of users. The person only needs to contact agent 120, which can handle and route incoming communication requests and messages. Additionally, agent 120 is capable of initiating a dialog with the person, if the user or group of users is unavailable.

A user can contact agent 120 through a number of different modes of communication. Generally, agent 120 can be accessed through a client device, such as computing device 502 (for example a mobile device, laptop or desktop computer, which herein represents various forms of computing devices having a display screen, a microphone, a camera, a touch sensitive panel, etc., as required based on the form of input), or through a phone 504 wherein communication is made audibly or through tones generated by phone 504 in response to keys depressed and wherein information from agent 120 can be provided audibly back to the user.

More importantly, though, agent 120 is unified in that whether information is obtained through device 502 or phone 504, agent 120 can support either mode of operation. Agent 120 can be operably coupled to multiple interfaces to receive communication messages. IP interface 506 receives information using packet switching technologies, for example using TCP/IP. POTS (Plain Old Telephone System, also referred to as Plain Old Telephone Service) interface 508 can interface with any type of circuit switching system including a Public Switch Telephone Network (PSTN), a private network (for example a corporate Private Branch Exchange (PBX)) and/or combinations thereof. Thus, POTS interface 508 can include an FXO (Foreign Exchange Office) interface and an FXS (Foreign Exchange Station) interface for receiving information using circuit switching technologies. P interface 506 and POTS interface 508 can be embodied in a single device such as an analog telephony adapter (ATA). Other devices that can interface and transport audio data between a computer and a POTS can be used, such as “voice modems” that connect a POTS to a computer using a telephone application program interface (TAPI).

In this manner, agent 120 serves as a bridge between the Internet domain and the POTS domain. In one example, the bridge can be provided at an individual personal computer with a connection to the Internet. Additionally, agent 120 can operate in a peer-to-peer manner with any suitable device, for example device 502 and/or phone 504. Furthermore, agent 120 can communicate with one or more other agents and/or services.

As illustrated in FIG. 5, device 502 and agent 120 are commonly connected, and separately addressable, through a network 510, herein a wide area network such as the Internet. It therefore is not necessary that device 502 and agent 120 be physically located adjacent each other. Device 502 can transmit data, for example speech, text and video data; using a specified protocol to IP interface 506. In one embodiment, communication between client 502 and EP interface 506 uses standardized protocols, for example TCP/IP (Transmission Control Protocol/Internet Protocol) and SIP with RTP (Session Initiator Protocol with Realtime Transport Protocol).

Access to agent 120 through phone 504 includes connection of phone 504 to a wired or wireless telephone network 512 that, in turn, connects phone 504 to agent 120 through a FXO interface. Alternatively, phone 504 can directly connect to agent 120 through a FXS interface.

Both IP interface 506 and POTS interface 508 connect to agent 120 through a communication application program interface (API) or communication module 514. One implementation of communication API 514 is Microsoft Real-Time Communication (RTC) Client API, developed by Microsoft Corporation of Redmond, Wash. Another implementation of communication APT 514 is the Computer Supported Telecommunication Architecture (ECMA-269/ISO 120651), or CSTA, an TSO/ECMA standard. Communication API 514 can facilitate multimodal communication applications, including applications for communication between two computers, between two phones and between a phone and a computer. Communication API 514 can also support audio and video calls, text-based messaging and application sharing. Thus, agent 120 is able to initiate communication to device 502 and/or phone 504. Alternatively, another agent and/or service can be contacted by agent 120.

To unify communication control for POTS and P networks, agent 120 is able to translate POTS protocols into corresponding IP protocols and vice versa. Some of the translations are straightforward. For example, agent 120 is able to translate an incoming phone call from POTS into an invite message (for example a SIP IMITE message) in the IP network, and a disconnect message (for example a SIP BYE message), which corresponds to disconnecting a phone call in POTS.

However, some of the IP-POTS translations involve multiple cohesive steps. For example, a phone call originated in POTS may reach the user on the IP network with agent 120 using an ATA connected to an analog phone line. The user may direct the agent 120 to transfer the communication to a third party reachable only through a POTS using a refer message (for example a SIP REFER message). The ATA fulfills the intent of the SIP REFER message using call transfer conventions for the analog telephone line. Often, call transfer on analog phone lines involves the following steps: (1) generating a hook flash, (2) waiting for a second dial tone, (3) dialing the phone number of the third party recipient, and (4) detecting the analog phone call connection status and generating corresponding SIP messages (e.g., a ringing connection in an analog phone corresponds to a REFER ACCEPTED and a busy tone to a REFER REJECTED, respectively).

Agent 120 also includes a service manager 122, a personal information manager (PIM) 518, a presence manager 520, a personal information and preferences depository 522 and a speech application 524. Service manager 516 includes logic to handle communication requests and messages from communication API 514. This logic can perform several communication tasks including answering, routing and filtering calls, recording voice and video messages, analyzing and storing text messages, arranging calendars, schedules and contacts as well as facilitating individual and conference calls through both IP interface 506 and POTS interface 508.

Service manager 122 also can define a set of rules for which to contact a user and interact with users connecting to agent 120 via communication API 514. Rules that define how to contact a user are referred to as “Find Me/Follow Me” features for communication applications. For example, a user associated with agent 120 can identify a home phone number, an office phone number, a mobile phone number and an email address within personal information and preferences depository 522 for which agent 120 can attempt to contact the user. Additionally, persons contacting agent 120 can have different priority settings such that, for certain persons, calls can always be routed to the user.

Service manager 122 can also perform various natural language processing tasks. For example, service manager 122 can access speech application 524 that includes a recognition engine used to identify features in speech input. Recognition features for speech are usually words in the spoken language. In one particular example, a grammar can be used to recognize text within a speech utterance. As is known, recognition can also be provided for handwriting and/or visual inputs.

Service manager 122 can use semantic objects to access information in PIM 518. As used herein, “semantic” refers to a meaning of natural language expressions. Semantic objects can define properties, methods and event handlers that correspond to the natural language expressions.

A semantic object provides one way of referring to an entity that can be utilized by service manager 122. A specific domain entity pertaining to a particular domain application can be identified by any number of different semantic objects with each one representing the same domain entity phrased in different ways.

The term semantic polymorphism can be used to mean that a specific entity may be identified by multiple semantic objects. The richness of the semantic objects, that is the number of semantic objects, their interrelationships and their complexity, corresponds to the level of user expressiveness that an application would enable in its natural language interface. As an example of polymorphism “John Doe”, “VP of NISD”, and “Jim's manager” all refer to the same person (John Doe) and are captured by different semantic objects PersonByName, PersonByJob, and PersonByRelationship, respectively.

Semantic objects can also be nested and interrelated to one another including recursive interrelations. In other words, a semantic object may have constituents that are themselves semantic objects. For example, “Jim's manager” corresponds to a semantic object having two constituents: “Jim” which is a “Person” semantic object and “Jim's Manager” which is a “PersonByRelationship” semantic object. These relationships are defined by a semantic schema that declares relationships among semantic objects. In one embodiment, the schema is represented as a parent-child hierarchical tree structure. For example, a “SendMail” semantic object can be a parent object having a “recipient” property referencing a particular person that can be stored in PIM 518. Two example child objects can be represented as a “PersonByName” object and a “PersonByRelationship” object that are used to identify a sender of a mail message from PIM 518.

Using service manager 122, PIM 518 can be accessed based on actions to be performed and/or semantic objects. As appreciated by those skilled in the art, PIM 518 can include various types and structures of data that can manifest themselves in a number of forms such as, but not limited to, relational or objected oriented databases, Web Services, local or distributed programming modules or objects, XML documents or other data representation mechanism with or without annotations, etc. Specific examples include contacts, appointments, text and voice messages, journals and notes, audio files, video files, text files, databases, etc. Agent 120 can then provide an output using communication API 514 based on the data in PIM 518 and actions performed by service manager 122.

PIM 518 can also include an indication of priority settings for particular contacts. The priority settings can include several levels of rules that define how to handle communication messages from a particular contact. For example, one contact can have a high priority (or VIP) setting in which requests and/or messages are always immediately forwarded to the user associated with agent 120. Contacts with a medium priority setting will take a message from the contact if the user is busy and forward an indication of a message received to the user. Contacts with a low setting will have messages taken that can be access by the user at a later time. In any event, numerous settings and rules for a user's contacts can be set within PIM 518, which are not limited to the situations discussed above.

Presence manager 520 includes an indicator of a user's availability. For example, a presence indicator can be “available”, “busy”, “stepped out”, “be right back”, “on the phone”, or “offline”. Presence manager 520 can interact with service manager 122 to handle communication messages based on the indicator. In addition to the presence indicators identified above, presence manager 520 also includes a presence referred to as “delegated presence”.

When presence manager 520 indicates that presence is delegated, agent 120 serves as an automatic message handler for a user or group of users. Agent 120 can automatically interact with persons wishing to contact the user or group of users associated with agent 120. For example, agent 120 can route an incoming call to a user's cell phone, or prompt a person to leave a voicemail message. Alternatively, agent 120 can arrange a meeting with a person based on information contained in a calendar of the PIM 518. When agent 120 is associated with a group of users, agent 120 can route a communication request in a number of different ways. For example, the request can be routed based on a caller identification of a person, based on a dialog with the person or otherwise.

Personal information and preferences depository 522 can include personal information for a particular user including contact information such as email addresses, phone numbers and/or mail addresses. Additionally, depository 522 can include information related to audio and/or electronic books, music, personalized news, weather information, traffic information, stock information and/or services that provide these specific types of information. Additionally, depository 522 can include customized information to drive speech application 524. For example, depository 522 can include acoustic models, user voice data, voice services that a user wishes to access, a history of user behavior, models that predict user behavior, modifiable grammars for voice services, personal data such as log-in names and passwords and/or voice commands.

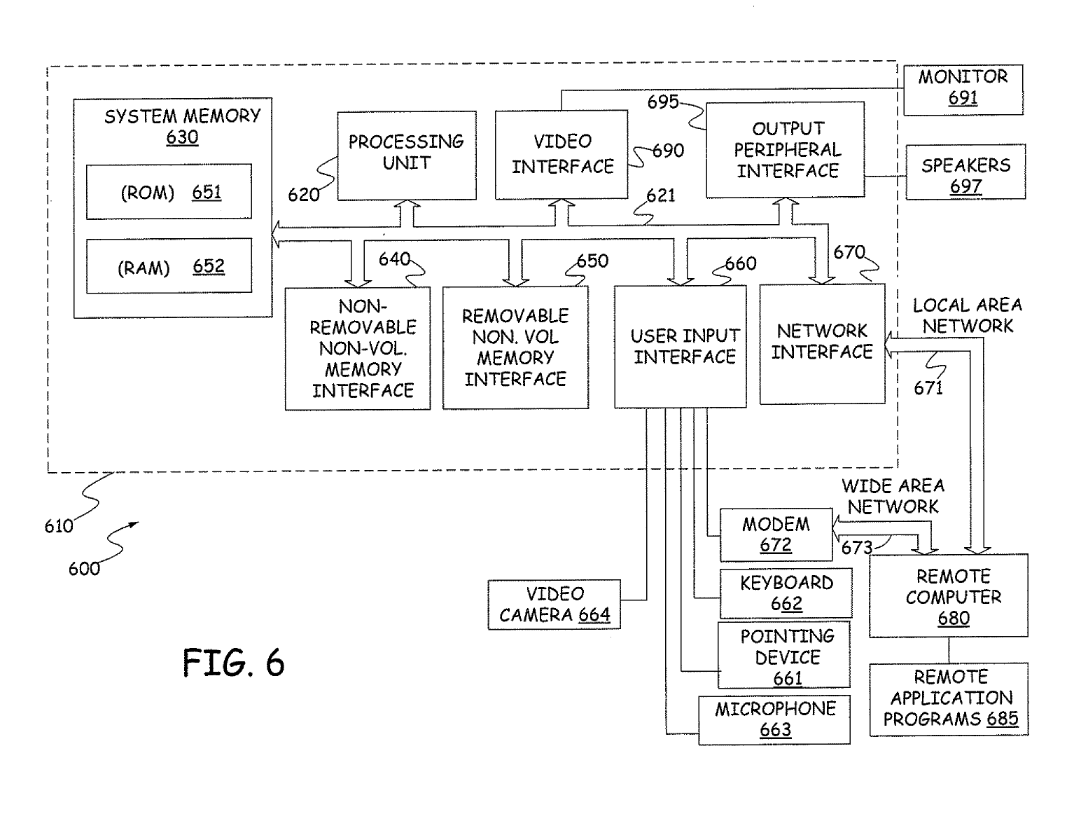

The computing environment shown in FIG. 6 is one such example that can be used to implement the service agent and/or be implemented as a client device. In FIG. 6, the computing system environment 600 is only one example of a suitable computing environment and is not intended to suggest any limitation as to the scope of use or functionality of the claimed subject matter. Neither should the computing environment 600 be interpreted as having any dependency or requirement relating to any one or combination of components illustrated in the exemplary computing environment 600.

Computing environment 600 illustrates a general purpose computing system environment or configuration. Examples of well-known computing systems, environments, and/or configurations that may be suitable for use with the service agent or a client device include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments may be described in the general context of computer-executable instructions, such as program modules, being executed by a computer. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices.

Exemplary environment 600 for implementing the above embodiments includes a general-purpose computing system or device in the form of a computer 610. Components of computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 610 typically includes a variety of computer readable media. Computer readable media can be any available media that can be accessed by computer 610 and includes both volatile and nonvolatile media, removable and nonremovable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data.

The system memory 630 includes computer storage media in the form of volatile and/or nonvolatile memory such as read only memory (ROM) 631 and random access memory (RAM) 632. The computer 610 may also include other removable/non-removable volatile/nonvolatile computer storage media. Non-removable non-volatile storage media are typically connected to the system bus 621 through a non-removable memory interface such as interface 640. Removable non-volatile storage media are typically connected to the system bus 621 by a removable memory interface, such as interface 650.

A user may enter commands and information into the computer 610 through input devices such as a keyboard 662, a microphone 663, a pointing device 661, such as a mouse, trackball or touch pad, and a video camera 664. These and other input devices are often connected to the processing unit 620 through a user input interface 660 that is coupled to the system bus, but may be connected by other interface and bus structures, such as a parallel port or a universal serial bus (USB). A monitor 691 or other type of display device is also connected to the system bus 621 via an interface, such as a video interface 690. In addition to the monitor, computer 610 may also include other peripheral output devices such as speakers 697, which may be connected through an output peripheral interface 695.

The computer 610, when implemented as a client device or as a service agent, is operated in a networked environment using logical connections to one or more remote computers, such as a remote computer 680. The remote computer 680 may be a personal computer, a hand-held device, a server, a router, a network PC, a peer device or other common network node, and typically includes many or all of the elements described above relative to the computer 610. The logical connections depicted in FIG. 6 include a local area network (LAN) 671 and a wide area network (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660, or other appropriate mechanism. In a networked environment, program modules depicted relative to the computer 610, or portions thereof may be stored in the remote memory storage device. By way of example, and not limitation, FIG. 6 illustrates remote application programs 685 as residing on remote computer 680. It will be appreciated that the network connections shown are exemplary and other means of establishing a communications link between computers may be used.

Besides computer 610 being used as a client device, mobile devices can also be used as client devices. Mobile devices can be used in various computing settings to utilize service agent 216 across the network-based environment. For example, mobile devices can interact with service agent 216 using natural language input of different modalities including text and speech. The mobile device as discussed below is exemplary only and is not intended to limit the present invention described herein.

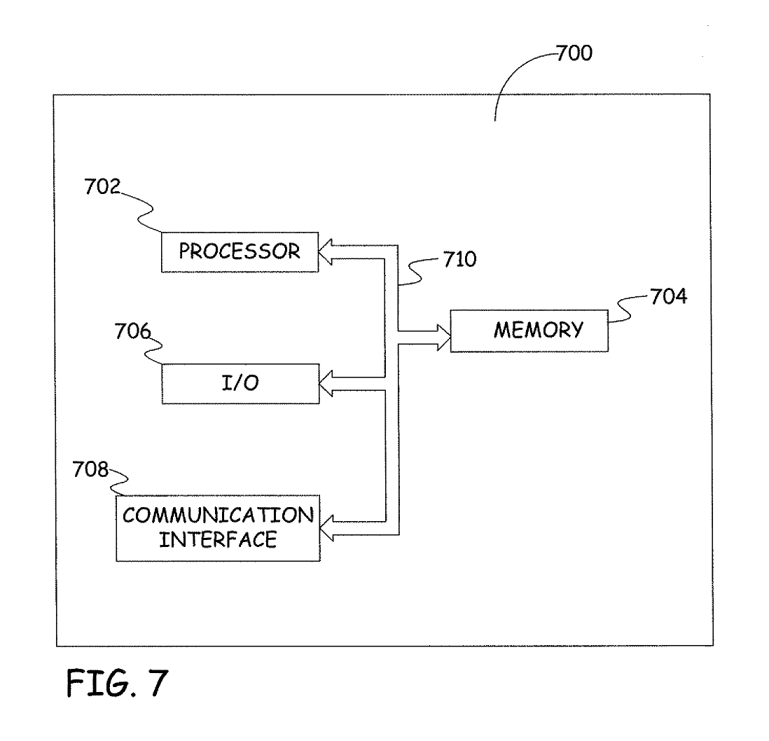

FIG. 7 is a block diagram of a data management mobile device 700, which is an exemplary client device for the network-based service environment 100. Mobile device 700 includes a microprocessor 702, memory 704, input/output (I/O) components 706, and a communication interface 708 for communicating with remote computers or other mobile devices. In one embodiment, the aforementioned components are coupled for communication with one another over a suitable bus 710.

Memory 704 is implemented as non-volatile electronic memory such as random access memory (RAM) with a battery back-up module (not shown) such that information stored in memory 704 is not lost when the general power to mobile device 700 is shut down. A portion of memory 704 is preferably allocated as addressable memory for program execution, while another portion of memory 704 is preferably used for storage, such as to simulate storage on a disk drive.

Communication interface 708 represents numerous devices and technologies that allow mobile device 700 to send and receive information. The devices include wired and wireless modems, satellite receivers and broadcast tuners to name a few. Mobile device 700 can also be directly connected to a computer to exchange data therewith. In such cases, communication interface 708 can be an infrared transceiver or a serial or parallel communication connection, all of which are capable of transmitting streaming information.

Input/output components 706 include a variety of input devices such as a touch-sensitive screen, buttons, rollers, and a microphone as well as a variety of output devices including an audio generator, a vibrating device, and a display. The devices listed above are by way of example and need not all be present on mobile device 700. In addition, other input/output devices may be attached to or found with mobile device 700.

Mobile device 700 can also include an optional recognition program (speech, DTMF, handwriting, gesture or computer vision) stored in memory 704. By way of example, in response to audible information, instructions or commands from a microphone provides speech signals, which are digitized by an A/D converter. The speech recognition program can perform normalization and/or feature extraction functions on the digitized speech signals to obtain intermediate speech recognition results. Similar processing can be used for other forms of input. For example, handwriting input can be digitized with or without pre-processing on device 700. Like the speech data, this form of input can be transmitted to a server for recognition wherein the recognition results are returned to at least one of the device 700 and/or a remote agent. Likewise, DTMF data, gesture data and visual data can be processed similarly. Depending on the form of input, device 700 would include necessary hardware such as a camera for visual input.

Mobile device 700 can also function as a plain old telephone. A phone includes a display and a keypad. Mobile device 700 can require additional circuitry to perform telephone functions. For instance, a transceiver is necessary to operate the mobile device as a phone.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method of managing tokens in a network of users, the method comprising:
creating a connection token that has a plurality of defined terms, the connection token is representative of a commitment of time of a first user in the network of users to engage in a real-time communication with at least one other in the network of users in exchange for a fee;
managing possession of the connection token amongst the users of the network; and
executing the connection token in accordance with the defined terms and connecting one of the users who is in possession of the connection token with the first user in the real-time communication.

2. The method of claim 1, wherein creating the connection token comprises creating an interruption token, the interruption token is representative of a right of one of the users of the network to interrupt the first user to engage in the real-time communication in exchange for the fee.

3. The method of claim 1, wherein creating the connection token comprises creating an advertisement token, the advertisement token is representative of the commitment of time of the first user to listen and/or view at least one advertisement provided by one of the users of the network in exchange for the fee.

4. The method of claim 1, wherein the real-time connection comprises one of an instant messaging connection, a telephone connection, a cell phone connection, a voice over Internet Protocol connection, a videoconferencing connection and a teleconferencing connection.

5. The method of claim 1, wherein creating the connection token comprises creating a professional advice token that is representative of a commitment of time of the first user in the network to engage in the real-time communication with the at least one other user in the network of users for the fee, the first user being an expert in a particular subject.

6. The method of claim 1, further comprising transferring the fee to the first user.

7. The method of claim 6, further comprising charging a percentage of a value of the fee transferred to the first user.

8. The method of claim 1, further comprising accessing an advertisement service to feed to the first user and the user in possession of the connection token during execution of the connection token.

9. The method of claim 1, wherein executing the connection token by connecting one of the users in possession of the connection token with the first user in the real-time communication comprises executing the connection token by anonymously connecting one of the users in possession of the connection token with the first user in the real-time communication.

10. The method of claim 1, further comprising managing reputations of the users of the network by:
collecting user review about other users of the network; and
providing each user of the network with a reputation value based at least on the collected reviews.

11. The method of claim 1, farther comprising policing the execution of the connection token to prevent abuse.

12. The method of claim 11, wherein policing the execution of the connection comprises recording the real-time communication.

13. A system (500) for managing tokens in a network of users comprising:
a service manager configured to:
create a connection token that has a plurality of defined terms, the connection token is representative of a commitment of time of a first user in the network of users to engage in a real-time communication with at least one other user in the network of users for a fee;
manage possession of the connection token amongst the users of the network;
and
a connection module configured to execute the connection token and connect one of the users in possession of the connection token with the first user in the real-time communication.

14. The system of claim 13, wherein one of the plurality of defined terms of the connection token comprises a transferability term.

15. The system of claim 13, wherein one of the plurality of terms of the connection token comprises a restriction on use term.

16. The system of claim 13, wherein the connection module connects one of the users of the network with the first user using a real time communication, wherein the real time communication comprises one of a telephone communication, a voice over Internet Protocol communication, and instant messaging communication, videoconferencing communication and a teleconferencing communication.

17. A method of committing time to engage in a real-time communication in a network of users, the method comprising:
instructing a service manager to create a connection token that has a plurality of defined terms, the connection token is representative of a commitment of time to engage in the real-time communication with a user of the network of users in exchange for a fee;
receiving the fee; and
participating in the real-time communication with a user of the network of users that is in possession of the connection token.

18. The method of claim 17, wherein instructing the service manager to create a connection token comprises instructing the service manager to create an interruption token, the interruption token is representative of the commitment of time to allow one of the users of the network to interrupt to engage in a real-time communication in exchange for the fee.

19. The method of claim 17, wherein instructing the service manager to create a connection token comprises instructing the service manager to create an advertisement token, the advertisement token is representative of the commitment of time to listen and/or view at least one advertisement provided by one of the users of the network in exchange for the fee.

20. The method of claim 17, wherein instructing the service manager to create a connection token comprises instructing the service manager to create a professional advice token that is representative of a commitment of time to engage in the real-time communication with another user in the network of users for a fee to provide professional advice about a particular subject. cm 1. A method of managing tokens in a network of users, the method comprising:
creating a connection token that has a plurality of defined terms, the connection token is representative of a commitment of time of a first user in the network of users to engage in a real-time communication with at least one other in the network of users in exchange for a fee;
managing possession of the connection token amongst the users of the network; and
executing the connection token in accordance with the defined terms and connecting one of the users who is in possession of the connection token with the first user in the real-time communication.

2. The method of claim 1, wherein creating the connection token comprises creating an interruption token, the interruption token is representative of a right of one of the users of the network to interrupt the first user to engage in the real-time communication in exchange for the fee.

3. The method of claim 1, wherein creating the connection token comprises creating an advertisement token, the advertisement token is representative of the commitment of time of the first user to listen and/or view at least one advertisement provided by one of the users of the network in exchange for the fee.

4. The method of claim 1, wherein the real-time connection comprises one of an instant messaging connection, a telephone connection, a cell phone connection, a voice over Internet Protocol connection, a videoconferencing connection and a teleconferencing connection.

5. The method of claim 1, wherein creating the connection token comprises creating a professional advice token that is representative of a commitment of time of the first user in the network to engage in the real-time communication with the at least one other user in the network of users for the fee, the first user being an expert in a particular subject.

6. The method of claim 1, further comprising transferring the fee to the first user.

7. The method of claim 6, further comprising charging a percentage of a value of the fee transferred to the first user.

8. The method of claim 1, further comprising accessing an advertisement service to feed to the first user and the user in possession of the connection token during execution of the connection token.

9. The method of claim 1, wherein executing the connection token by connecting one of the users in possession of the connection token with the first user in the real-time communication comprises executing the connection token by anonymously connecting one of the users in possession of the connection token with the first user in the real-time communication.

10. The method of claim 1, further comprising managing reputations of the users of the network by:
collecting user review about other users of the network; and
providing each user of the network with a reputation value based at least on the collected reviews.

11. The method of claim 1, further comprising policing the execution of the connection token to prevent abuse.

12. The method of claim 11, wherein policing the execution of the connection comprises recording the real-time communication.

13. A system for managing tokens in a network of users comprising:
a service manager configured to:
create a connection token that has a plurality of defined terms, the connection token is representative of a commitment of time of a first user in the network of users to engage in a real-time communication with at least one other user in the network of users for a fee;
manage possession of the connection token amongst the users of the network; and
a connection module configured to execute the connection token and connect one of the users in possession of the connection token with the first user in the real-time communication.

14. The system of claim 13, wherein one of the plurality of defined terms of the connection token comprises a transferability term.

15. The system of claim 13, wherein one of the plurality of terms of the connection token comprises a restriction on use term.

16. The system of claim 13, wherein the connection module connects one of the users of the network with the first user using a real time communication, wherein the real time communication comprises one of a telephone communication, a voice over Internet Protocol communication, and instant messaging communication, videoconferencing communication and a teleconferencing communication.

17. A method of committing time to engage in a real-time communication in a network of users, the method comprising:
instructing a service manager to create a connection token that has a plurality of defined terms, the connection token is representative of a commitment of time to engage in the real-time communication with a user of the network of users in exchange for a fee;
receiving the fee; and
participating in the real-time communication with a user of the network of users that is in possession of the connection token.

18. The method of claim 17, wherein instructing the service manager to create a connection token comprises instructing the service manager to create an interruption token, the interruption token is representative of the commitment of time to allow one of the users of the network to interrupt to engage in a real-time communication in exchange for the fee.

19. The method of claim 17, wherein instructing the service manager to create a connection token comprises instructing the service manager to create an advertisement token, the advertisement token is representative of the commitment of time to listen and/or view at least one advertisement provided by one of the users of the network in exchange for the fee.

20. The method of claim 17, wherein instructing the service manager to create a connection token comprises instructing the service manager to create a professional advice token that is representative of a commitment of time to engage in the real-time communication with another user in the network of users for a fee to provide professional advice about a particular subject.
